(19) United States
(12) Patent Application Publication
(10) Pub. No.: US 2006/0023238 A1
(43) Pub. Date: Feb. 2, 2006

(54) Select reprint of records in variable data printing

(75) Inventors: David V. Blaszyk, Spencerport, NY (US); Walter R. Albers, Webster, NY (US); Christine M. Balestra, Rochester, NY (US); Timothy F. Donahue, Mendon, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/903,075

(22) Filed: Jul. 30, 2004

(51) Int. Cl. G06F 3/12

(52) U.S. Cl. 358/1.13

(57) ABSTRACT

A method and system for selective reprint of individual records in a variable data printing operation in which a variable data print job defined by an original digital document having a plurality of records to be printed is provided to the printing device (2). The variable data print job is run on the printing device (2) and the printed documents are examined to select records to reprint. A parameter (64) that identifies the records to reprint is determined and applied to the original digital document (50) using a data transformation engine (60). The data transformation engine (60) transforms the original digital document (50) into a new (70) or revised (50′) digital document including the records to reprint and provides the print job defined by the new (70) or revised (50′) digital document to the printing device (2) for selective reprint. The digital document (50) is an electronic file having a digital content component (51) encoded in PDF format, and a digital markup file component (52) specified using XML. The data transformation engine (60) applies a data transform to the digital markup file (52) based on XSLT.

### CROSS-REFERENCE TO RELATED APPLICATIONS

This application is related to, and contains common disclosure with, co-pending and commonly assigned patent applications: “Method and Apparatus for Using Fields of Data to Organize Variable Data Print Jobs”, Ser. No. 10/118,773, patent publication number U.S. 2003/0189727; “Variable Data Printing Using Family Groupings”, Ser. No. 10/118,771, patent publication number U.S. 2003/0189725; “Variable Data Printing Using Variants”, Ser. No. 10/118,770, patent publication number U.S. 2003/0189724; and “Variable Data Printing Dynamic Imposition Template”, Ser. No. 10/118,772, patent publication number U.S. 2003/0189726, all filed on Apr. 9, 2002, and “Finish Verification in Printing”, Ser. No. 10/263,438, patent publication number U.S. 2004/0066527, filed on Oct. 2, 2002.

### FIELD OF THE INVENTION

The present invention relates to processing variable data print jobs, and more particularly, to extraction and reprinting of selected records produced with production printing processes using variable data printing.

### BACKGROUND OF THE INVENTION

Variable Data Printing (VDP) is a form of printing that produces individualized printed pieces, each of which contain printed pages containing information targeted to an individual recipient. VDP authoring combines the graphical arts practice of graphical page authoring with Information Technology (IT) to provide utility to create variable data print jobs that will be input to one or more print production processes in which the printed and finished pieces are manufactured. The various variable content instance documents comprising a VDP job are authored based on data drawn from a database containing records of information that characterizes the individual recipients. VDP is seen as having the potential to enable the high degree of one-to-one marketing communications for the graphic arts and printing industries as has been seen in one-to-one marketing practice using communication mediums such as the Internet.

A common problem that exists using VDP is that making print jobs using variable data will typically take longer for a raster image processor (RIP) to rasterize and print than a conventional static print job using non-variable data. Variable print data is sent to a RIP where code for text elements and graphic elements are processed into a raster data format that can be utilized by the marking engine of a digital printer. Therefore, every page having variable data must have each and every code element raster image processed (RiPped). The necessity of having to individually RIP the elements having variable data creates a substantial processing bottleneck compared to RIPping static print jobs comprised of a single document, which need only be RIPped once, and the many copies are imaged from the same RIPped result.

Beyond the conventional variable data printing practice of varying page content for respective instance documents, it is also possible to vary other characteristics of the printed pieces such as finishing characteristics including binding style, and substrate selection based on rules sensitive to the same recipient database information used in the conditional mapping of page content. In this way, for example, recipients of higher value to the marketing firm for which the VDP job is produced, can receive a printed piece on a higher quality print media with a higher quality binding, whereas, their lower value customers with less value potential may only receive a corner stapled document that is less expensive to produce but has sufficient marketing impact to be noticed by the intended recipient. This implies the need to store along with the page content and layout data, additional data that expresses the physical characteristics of each piece to be manufactured known as product intent data. The addition of product intent data, which may vary the physical characteristics of the finished documents of the VDP job based on the data profile of the various recipients, may add significant complexity to the manufacturing process workflow in the print provider's environment where the required workflow may not be achievable. Hence, a significant problem exists where it is possible to author a VDP job without knowledge of the print providers manufacturing workflow capabilities that is too complex to be produced.

Accordingly, there is an ongoing desire within the graphic arts industry to correct the previously discussed shortcomings within the prior art and to enable a faster form of VDP up to final print production and finishing. It is also desirable to use currently practiced methodology within the print engine. The graphic arts industry needs both a method and an apparatus that can provide an efficient and reliable exchange of variable data for use in variable data print jobs.

A page definition mark up language, called Personalized Print Markup Language (PPML), developed by the Print On Demand Initiative (PODi) is an example of a data format that can represent the layout of the pages of the many unique instance documents of a variable data print job. PPML is based on the Extensible Markup Language (XML) and is structured in such a way that content data that is used multiple times under the same rendering context on one or more pages is explicitly identified so as to enable a consuming RIP process opportunities for improved processing performance. Ideally, a PPML RIP would process all content elements, including both the identified reused and non-reused content elements, a single time where the re-used elements are stored in a cache after they are first RIPped and then reused as raster data.

Allowing a printer RIP to store and re-use rasterized graphic elements as needed provides a tremendous improvement in processing performance. The ability to re-use these elements also eliminates the need to resend the source code that defines the content element to the printer/RIP multiple times during the same print job. PPML is a significant advancement for variable data printing because it allows a printer/RIP to understand at an object level rather than a page level. It allows a printer/RIP to have a certain degree of intelligence and manipulate the components (objects) that make up a page. It also provides code developers the ability to name objects, which permits the re-use of the objects as needed during printing of a variable-data job.

Variable Data Exchange (VDX) is a standard that has recently been evolving within the Committee for Graphic Arts Technologies Standards (CGATS), as a production tool for variable data in the form of a VDX instance combined with PPML. A VDX instance can be looked at as a compilation of records that define the content and layout of many composite pages. These VDX instances can be used with PPML to create the composite definitions of PPML/VDX instance documents. PPML/VDX defines a verifiable data format that enables designers and printers to exchange final form, variable documents electronically. A PPML/VDX compliant job includes creative content from current design applications and variable information from common database applications. PPML/VDX deals with the exchange of content information as well as data that represents the final look of variable print products. Each composite page of a PPML/VDX instance document is an assembly of one or more partial pages or content objects referred to as compound elements. PPML/VDX allows compound elements to be defined once and referenced many times from the various composite page layout instances to effectively reduce the overall size of data for a PPML/VDX instance.

The layout data that describes the composite pages of a PPML/VDX instance is defined using a subset of the previously described PPML. The data format required by the PPML/VDX standard for defining the compound element source data is the Portable Document Format (PDF) defined and maintained by Adobe Systems. In PPML/VDX, the source Page Definition Language (PDL) data that defines a compound element that is placed on a PPML defined page layout is always expressed as a page of a PDF file. PDF files used to define PPML/VDX compound elements must contain all the supporting resources such as fonts, image data, and color profiles. PDF files used to define PPML/VDX compound elements must also define all color content in a known reference device or device independent color-space.

VDX requires that the PPML layout data of a VDX instance be stored as a single, randomly accessible PDF object stream that is stored within a PDF file. Depending upon the conformance level, the PDF file embedding the PPML data may also contain some, or possibly all, of the PDF page object definitions required by the VDX instance that results in a PPML layout data object. The PPML/VDX file has an XML element that contains the PPML and product intent data, referred to as the PPML/VDX Layout file. PDF files contain only PDF page objects used for defining compound element definitions and have no XML elements stored within them and may be referenced from the PPML data store in a PPML/VDX Layout file. These PDF files are referred to as a PPML/VDX Content file.

A completely specified device and production workflow independent VDP job definition is comprised of three basic components, two of which define the appearance of the variable page content, namely layout (also referred to as mark-up) data, and content data. In a PPML/VDX instance, the layout component is defined by the PPML data, and the content component is defined by the PDF data. The third component, known as product intent data, provides the description of the finished product. The product intent data typically includes information such as document binding styles, single and/or two sided print options, substrate types, and other attributes of a print product description required for communicating to a print service provider the definition of the final print products that are to be manufactured. Product intent information does not define the controls of a particular target manufacturing process or device because such information is usually not known to the PPML/VDX authoring agent. These device control parameters are usually only known to the print provider who receives the exchanged VDP job data. The print provider, therefore, must derive the manufacturing specifications specific to their production workflow or workflows from the product intent, layout, and content data specification created by their customer.

A PPML/VDX instance is created by a data driven merge process referred to as a variable data merge engine. The merge engine typically executes within an authoring environment for variable data. The authoring environment can be located at a different location from the graphic arts establishment that actually prints the final pages of the variable data documents. In some scenarios, a PPML/VDX instance may be sub-divided into several PPML/VDX instances that can be transferred to different locations to be printed. Generation of a PPML/VDX instance by the variable data merge engine is considered a final activity in the somewhat complex process for authoring variable data. The PPML/VDX instance can be transferred to a print production workflow within the same or different operating environment where it can be viewed by a prepress operator, and placed into a final production ready form that is suitable for the digital printer used at that location.

The PPML/VDX is a portable format that is expected to enable growth in the practice of variable data printing within the printing industry. PPML/VDX allows printers with dynamic digital printing capability to participate in variable printing without the need to acquire one-to-one marketing, variable layout design, or data processing expertise. However, PPML/VDX is strictly a final form variable data and layout format that is device independent. Therefore, PPML/VDX does not support the inclusion of data that is specific to a printing device such as imposition layout, trapping parameters, traps, or any printer or general device control information. Accordingly, data that contains specific information for a printing device needs to be added later during the prepress activity when the print job is being prepared for production.

From the foregoing discussion it should be apparent that there remains a need within the art for a method and apparatus that can supply printing device specific data to be used in conjunction with PPML/VDX instances to enable growth in the variable data printing practice within the printing industry.

### SUMMARY OF THE INVENTION

The present invention is directed to a method and system for selectively extracting and reprinting individual records produced during a production printing process using variable data printing.

The present invention addresses the problems within the prior art in order to enhance the variable data printing practice within the printing industry and facilitate the production of VDP jobs. A VDP job as used within the context of the invention consists of instance documents that significantly differ in terms of how they are to be produced. For example, the instance documents can vary in page length, the type of media used, the number of pages that exceed the imaging area, number of copies, and finishing. A VDP prepress workflow component provides the prepress operator with the ability to analyze and view the data of the VDP job, then setup the job within the digital press environment such that the VDP job can be optimally produced.

Preferably, the VDP prepress workflow component is an Acrobat plug-in. The plug-in is designed so that each feature can stand alone, and features can be either added or deleted incrementally. The VDP prepress workflow component is able to analyze, view, and prepare the VDP job for production. The output of the component is one or more “production ready” jobs.

In an exemplary embodiment, a method is provided for selective reprint of individual records in a variable data printing operation in which a variable data print job defined by a digital document having a plurality of records to be printed is sent electronically to the printing device. The variable data print job is run on the printing device and the printed documents are examined to select records to reprint. A parameter that identifies the records to reprint is determined and applied to the original digital document using a data transformation engine. The data transformation transforms the original digital document into a new digital document including the records to reprint and provides the print job defined by the new digital document to the printing device for selective reprint. The digital document is an electronic file having a digital content component encoded in Portable Document Format (PDF) language, and a digital markup file component specified using Extensible Markup Language (XML). The data transformation engine applies a data transform to the digital markup file based on Extensible Stylesheet Language for Transformations (XSLT).

These and other features of the invention are provided by a Variable Data Print job containing a plurality of documents that are to be printed, each of the plurality of documents being defined by a plurality of variants that include elements related to content, layout and product intent, herein at least a portion of the plurality of documents each contain a Field of Data having information specific to that document, selecting at least one parameter from the Field of Data and creating a plurality of groups in accordance with the parameter, and arranging the groups for printing in accordance to the parameter.

### BRIEF DESCRIPTION OF THE DRAWINGS

The invention is better understood by reading the following detailed description of the invention in conjunction with the accompanying drawings.

FIG. 1A is an illustration of the basic functions required for Variable Data Printing as envisioned by the invention;

FIG. 1B is an illustration of the preferred printing device for running the functions shown in FIG. 1A;

FIG. 2 is a diagram illustrating the prepress workflow of a print job from the authoring component to the production component;

FIG. 3 is a flow diagram illustrating the process of an exemplary embodiment of the present invention that characterizes the instance documents and classifies them into groups with common characteristics called families;

FIG. 4 is a flow diagram for the creation of families in accordance with an exemplary embodiment;

FIG. 5 is a flow diagram for an optional routine that allows the operator to create derivative jobs; and

FIG. 6 is a flow diagram illustrating a summary of the flow information to select certain records from a list of existing digital content files in accordance with the present invention.

### DETAILED DESCRIPTION OF THE INVENTION

The following description of the invention is provided as an enabling teaching of the invention in its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances and are a part of the present invention. Thus, the following description is provided as illustrative of the principles of the present invention and not in limitation thereof, since the scope of the present invention is defined by the claims.

The present invention presents a description of the sequence of actions that a system performs upon a Variable Data Print (VDP) job so that it can be produced efficiently. The VDP prepress workflow component provides a user-friendly utility to the prepress operator for facilitating the production of VDP jobs. A VDP job may include instance documents that differ significantly in terms of how they are to be produced. For example, instance documents may vary in term of: page quantity; media type; the number of pages that exceed the area that can be imaged; page layout (one-sided versus two sided); page orientation (portrait versus landscape); metadata; number of copies, and finishing. The VDP prepress workflow component provides the prepress operator with the ability to analyze and view the VDP job, and then setup the VDP job within the digital press environment using knowledge of the devices available in the environment such that the VDP job can be optimally produced.

The preferred embodiment provides the VDP prepress workflow component as an Acrobat plug-in. The Acrobat plug-in is preferably arranged within a modular architecture allowing each of numerous modules to be standalone, such that each of the modules can be added or deleted incrementally. The VDP prepress workflow component supports the PPML/VDX file format and allows the prepress operator to analyze, view, and prepare a VDP job for production. The output of the VDP prepress workflow component is a plurality of production ready jobs.

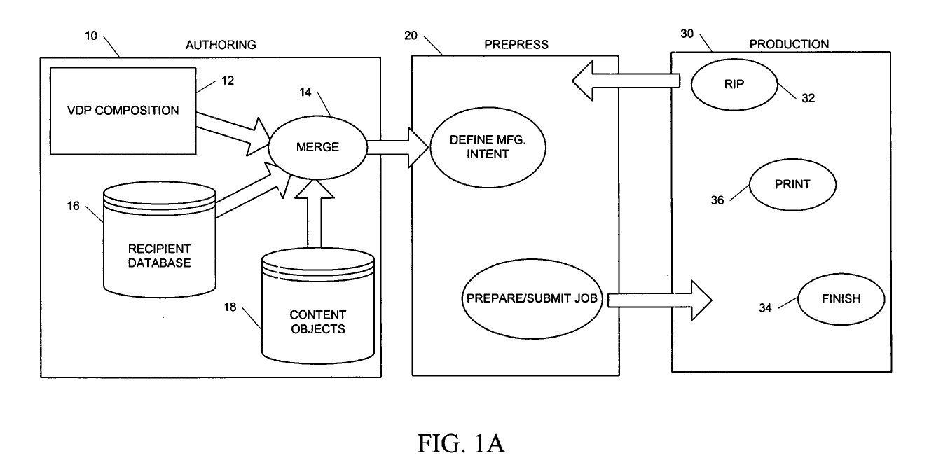

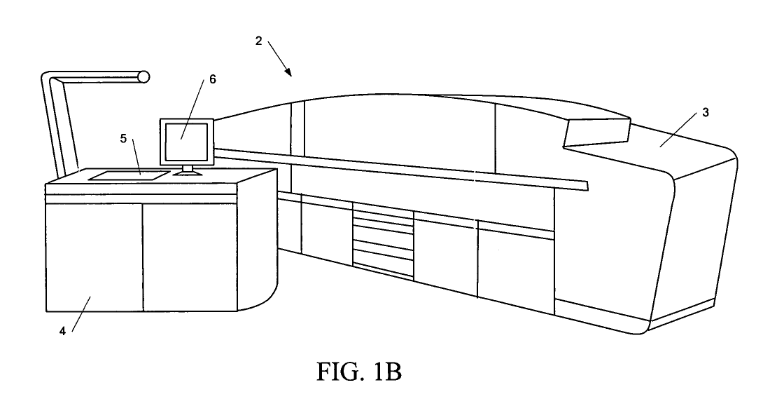

Referring to FIG. 1A, a VDP job as envisioned by the present invention is accomplished in three basic areas. Authoring component 10 provides the PPML/VDX file for the prepress component 20. The invention operates in the area of prepress component 20 to prepare the VDP job for production 30. FIG. 1B illustrates a NexPress 2100 digital printing system 2 with graphical user interface (GUI) 6 and NexStation front end 4 providing input and control for printer 3. All of the invention features described herein can be implemented on the NexPress 2100 digital printing system available from NexPress Solutions, LLC.

Authoring component 10 is typically performed by the graphic designer who adds variable content to static content using a utility within VDP composition process 12, to add variable content to traditional static designs produced by applications such as Quark and In Design. Within the PPML/VDX standard, information known as product intent data may be included in PPML/VDX job data that describes information such as required media types, and binding styles. These product intent elements are encoded into a job ticket. Each of these product intent characteristics are referenced from within the PPML data such that the instance document definitions defined in PPML data are provided with a product intent definition. In this way the characteristics of the finished documents such as binding style, media types, copy quantity, and number of pages that exceed the imaging area, all of which contribute to the definition of the finished print product, are explicitly specified for any given document. The present invention can employ NexTreme as the tool for VDP composition process 12 within authoring component 10. NexTreme is a proprietary authoring tool of NexPress Solutions, LLC that generates the PPML/VDX document provided to prepress component 20 and operates to create additional metadata in the form of extensions to the PPML/VDX variable data which is added by NexTreme. These extensions can be items taken from the recipient database records such as the recipient's age, gender, postal address, or any other variable data that is specifically associated with the recipient. Authoring component 10 will store these extensions as metadata within the PPML/VDX job. The prepress workflow application draws upon the product intent information including the metadata that is stored in the PPMLNDX job as enunciated by the graphics artist using NexTreme to identify the optimal job ticket specification for printing the job.

The variable data, within the preferred embodiment, comes from data in recipient databases 16 that characterize the targeted audience. Merge process 14 is a process wherein data from the recipient database 16, is combined with static content data that is contained in content objects database 18 to produce the merged PPML/VDX instance document. To understand the description of the merge process 14, a brief discussion of the hierarchical structure of a VDX file is needed.

A VDX file, as used herein, refers to the VDX portion of a PPML/VDX file. The PPML/VDX file utilizes PPML to describe the position of PDF objects on every page of a VDP job including one or more instance documents. As previously described, an authoring application is required to author a PPML/VDX job. The exemplary embodiment uses NexTreme, however, other VDP authoring applications can also be used to practice the invention. The graphical artist creates a template consisting of static images, graphics and text as well as variable images, graphics and text in VDP composition process 12. The variable parts of the layout will have an associated set of rules that describe the procedures necessary to create each instance document. For example, a print job could have a graphical box designated to contain a picture of an automobile for an advertisement to every person listed within a recipient database, the decision for the variable data that will be used for an automobile advertisement would be something like the following:
if (income>$100000) then Lexus.pdf;
else if (income>$50000) then Ford.pdf;
else Kia.pdf.
   Therefore, the Content objects 18 database must contain the following PDF files: Lexus.pdf, Ford.pdf, and Kia.pdf.

Once the VDP job is composed in a PPML/VDX file format, the merge process 14 generates an instance document for every record in the recipient database 16. The recipient database 16 is a file containing a database of records relating to metadata of the recipients. For example, the recipient database 16 could appear like Table 1 below.

TABLE 1

| NAME | INCOME | AGE |
|---|---|---|
| Jack Snow | $55,000 | 25 |
| Bob Smith | $120,000 | 55 |
| Jane Doe | $250,000 | 45 |
| Sally Jones | $12,000 | 21 |

During the merge process, the VDP authoring application looks at one record at a time from the recipient database 16, and generates a single instance document by using the template containing static and variable images, graphics and text. Merge process 14 applies the static objects to each of the instance documents using the rules as defined by the author for the inclusion of variable objects. In the above example, merge process 14 first generates an instance document (a VDX file) for Jack Snow. Merge process 14 then adds a picture to the instance document for Jack Snow and applies the rules that were given by the author during the authoring process which results in the system going to the recipient database 16 and retrieving the file, Ford.pdf. Finally, merge process 14 adds Ford.pdf into the VDX file and put an entry in the PPML portion of the file describing where Ford.pdf goes on a specific page for Jack Snow's instance document. The result after merge process 14 is a VDX file having a PPML portion that describes one instance document for each record in the recipient database 16, plus all of the images, graphics, and text objects which usually come from a content database 18.

The exemplary embodiment is a VDP system that is a scaleable, end-to-end solution utilizing an open PDF based workflow architecture that recognizes the importance of, and supports, the de-coupling of VDP authoring component 10 and VDP print production component 30. The process of de-coupling the VDP authoring component from the VDP print production component 30 has necessitated the creation of VDP prepress workflow components as a tool that can be used by the prepress operator during prepress 20 to optimally manufacture the VDP print job as described from the job producer. The VDP print job, which is received for processing during prepress 20 by the prepress operator, will contain anywhere from one to tens of thousands of instance documents which lack any structure in terms of pages per document, copies per document, media, pages exceeding imaging area requirements, and finishing options. To enable the accurate and efficient manufacturing of the entire VDP job as specified by the PPML/VDX file, the prepress 20 component will provide a set of tools to analyze, view, and prepare the VDP job for the production component 30. During production 30, the raster image processor (RIP) 32 will convert the code for each text and graphics element on every page into a format that can be printed by the print engine. After the VDP job has been RIPped, it is printed 36 and finished 34.

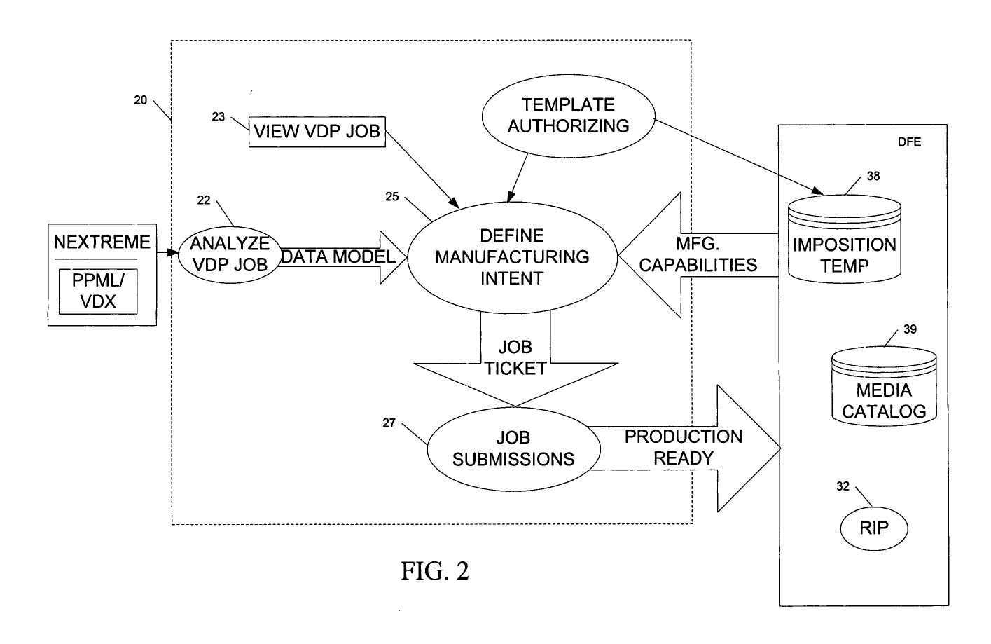

FIG. 2 is a diagram illustrating the workflow performed by the prepress component 20 after the PPML/VDX has been received from authoring component 10 through production component 30. The prepress component 20 as illustrated in FIG. 2, will take the VDP job as an input in the form of a PPML/VDX instance file and provide an output to production component 30 that is a VDP job that is ready to be printed.

The VDP prepress component 20 is preferably an Acrobat plug-in and provides functionality consistent with typical Acrobat plug-in “look and feel”. Preferably, prepress component 20 is provided with high-level functions that give the prepress component 20 the ability to: view a VDP job, analyze a VDP job; define production parameters for a VDP job; provide for VDP job submission; define the finish verification for a VDP job; and create derivative VDP jobs.

Still referring to FIG. 2, View VDP Job 23 allows the prepress operator to view the PPML/VDX file as it is to be finished and allows the prepress operator to view a PPML/VDX file, one page at a time, as it would look to the customer after being printed and finished. The prepress operator opens the PPML/VDX file while in the prepress 20 environment, and the first page of the first instance document is displayed. Under the standard Acrobat “Bookmarks” tab, the PPML/VDX file is divided on instance document boundaries. The prepress operator can select any instance document bookmark and view it's first page. View VDP Job 23 allows the prepress operator to utilize all standard Acrobat Page-Up/Page-Down features to view the PPML/VDX file. View VDP Job 23 can be run to allow viewing of a PPML/VDX file with minimal performance degradation compared to viewing PDF files by themselves.

The PPML/VDX file is tested upon being opened to determine if it is either “valid” or “well-formed”; definitions of “valid” and “well-formed” are specified by the Extensible Markup Language (XML) 1.0 and are specified by the prepress operator. Within the preferred embodiment, the VDP prepress software senses that it has opened a VDP file and enables all applicable VDP functionality. Once the PPML/VDX file is opened, the initial view is of the first page of the first document. The prepress operator views other pages by using standard Acrobat navigational tools.

The exemplary embodiment of the invention uses system software to allow viewing of PPML/VDX files as composed PPML/VDX pages (pre-imposed PPML/VDX pages). The default viewing level of the system software is to view all PPML/VDX files as composed PPML/VDX pages. The system software supports standard Acrobat navigation of pages in a PPML/VDX file by displaying them within the user interface with a unique numerical identifier for each instance document. The unique identifier will correspond to the top down order of the instance document in the PPML/VDX file. The first instance document is instance document #1.

The exemplary embodiment allows viewing of PPML/VDX pages in a PPML/VDX file as benchmarked against PDF files with little or no performance degradation because viewing a PPML/VDX file is equivalent to viewing a strictly PDF version of the content. The preferred embodiment also supports standard Acrobat bookmarks for identifying instance documents within instance documents. Additionally, the system software of the preferred embodiment supports pre-imposed views of PPML/VDX files within the network environment of the application. The system software also supports pre-imposed and imposed sheet views of PPML/VDX files within an accessible NexStation 4 environment. It should be noted that this involves supporting part of the proprietary interface to the NexStation 4.

The preferred embodiment allows the locking onto a specific page number of an instance document such that subsequent navigating via the Page Up/Down keys result in navigating to the same page number of the previous/next instance document if it exists.

The View VDP Job 23 performs a function that allows the PPML/VDX file to be viewed as it is to be printed (finished). This enables a prepress operator to view sheets within a PPML/VDX file, one at a time, as the sheets would look after being printed. Once the prepress operator successfully opens a PPML/VDX file with the prepress component, the option to view the file as imposed can be selected by the operator via the GUI 6. If an Adobe Job Ticket is already associated with the PPML/VDX file, the viewer shows the imposed sheet surface. This view includes page layout, relevant document marks (trim, fold, bleed, bar codes), and annotations. The preferred embodiment does not provide bookmarks in this view, because there is no rule preventing instance documents from overlapping on sheet surfaces. The prepress operator can utilize all standard Acrobat Page-Up/Page-Down features to view the PPML/VDX file. Minimal performance degradation can be expected while viewing a PPML/VDX file in the imposed view when benchmarked against viewing a PPML/VDX file in the pre-imposed view.

In order for the prepress operator to run View VDP job 23, the PPML/VDX file is first opened by system software and an Adobe Job Ticket is associated with the PPML/VDX file to describe the imposition layout for the VDP print job. The prepress operator selects an option via the GUI 6 that will allow viewing of the PPML/VDX file as it is be printed in imposed form. The prepress operator can view other pages as well by using standard Acrobat navigational tools. The preferred embodiment envisions allowing select viewing of the PPML/VDX file in an imposed form by supporting Adobe Job Ticket (PJTF and JDF) layout parameters. A sheet surface view of a PPML/VDX file as specified by the associated Adobe Job Ticket is provided with features such as page layout, document marks (trim, fold, bleed, bar codes), and annotations. The system software provides imposed views of PPML/VDX files within the network environment of the application. Imposed views of PPML/VDX files within an accessible NexStation 4 environment are also supported. Accordingly, the exemplary embodiment is described in a manner that is specific to a NexStation 2100 environment, however, variations will be readily apparent to those of ordinary skill in the art that can easily be ported on other pieces of equipment.

View PPML/VDX File as a List of PDF Objects (Not Composed)

View VDP Job 23 provides the prepress operator with the capability of viewing a PPML/VDX file, one PDF object at a time. In order to accomplish the viewing of single PDF object, the system provides viewing of the PPML/VDX file as a sequence of randomly accessible PDF objects. After the prepress operator successfully opens a PPML/VDX file with the software for the prepress component 20, the option to view the file as a randomly accessible list of PDF objects is selected. The viewing of the PPML/VDX file as a list of PDF objects can be helpful in debugging the appearance of the PPML/VDX content. There are no bookmarks in this view, since the objects in this view are independent of any page or instance document. The prepress operator can utilize all standard Acrobat Page-Up/Page-Down features to view the PPML/VDX file.

Analyze VDP Job

The routine Analyze VDP Job 22 allows the system to characterize all of the instance documents in the VDP job as they are delivered by the producer after authoring application 10. The characterization made by Analyze VDP Job 22 yields information that allows the prepress operator to accurately and efficiently manufacture the entire VDP job. A VDP job within the exemplary embodiment can include from one to more than 10,000 instance documents. The instance documents can vary in terms of: page count; the number of pages that exceed the area that can be imaged upon; number of copies; logical finishing (e.g., bind or saddle-stitch); page layout (e.g., one-sided, two-sided, head-to-head or two-sided, head to toe); or orientation, such as portrait or landscape. Also instance documents can have variations in the logical sequence of media required. For example, each of the following is a unique sequence of media: A4, A4, A4; A4, A4, A4, A4; A4, A4, A3 and A3, A3, A3, A3, A3. Additionally, metadata can vary in the instance documents. Metadata in the context of a VDP job typically refers to information extracted from the recipient database 16 and associated with an instance document. For example, a database 16 may have a field containing the zip code of each person to receive a brochure. The VDP authoring application may allow the author to associate the value of each recipient's zip code with the resulting instance document in the “Private_Info” element of a PPML/VDX file. This metadata information can then be used later in the workflow as a variant to a VDP Family.

Each of the variants within the instance documents is important because they impact how the printed document is to be produced which can impact the selection of a device, or the way a particular device is to be used; most notably, the imposition scheme.

Analyze VDP Job 22 characterizes all of the instance documents within a print job and places the characterized instance documents into groups referred to herein as VDP Families. A VDP Family is a group of instance documents having identical values for the set of variant parameters chosen by the prepress operator within a VDP job. From the list of VDP Families and their corresponding parameters, the prepress operator can determine how to manufacture the entire VDP job. With the benefit of the characterization from Analyze VDP Job 22 to work from, the prepress operator may choose to manufacture each VDP Family uniquely, or group any or all of the VDP Families together to be manufactured in a predetermined manner. Grouped VDP Families can be manufactured the same, or having some members of the group of VDP Families have one or more of the manufacturing variants be the same.

In order for the prepress operator to be able to navigate the VDP job within prepress 20, it is necessary to be able to analyze the VDP job functionality. Analyzing VDP Job functionality within the preferred embodiment is accomplished by selecting a tab for Analyze VDP Job 22 that is consistent with Acrobat “look and feel”. The prepress operator is given the opportunity to select which VDP Family variants to discriminate against. This could also mean supplying corresponding check boxes to each of the following variants: page count; media sequence; pages exceeding the imageable area; copy counts, layout sequence, orientation sequence, metadata; and finishing. The prepress operator clicks on a button that initiates the VDP job analysis. The VDP workflow prepress 20 scans the entire XML portion of the PPML/VDX file, and subsets the instance documents into VDP Families, which are a unique set of parameters as specified by the list of variants chosen by the prepress operator. The VDP prepress 20 displays in a clearly formatted text box for each Family, the number of instance documents it contains and the parameter value of each variant. For example:

Family 1—
Contains 935 instance documents
Page count=6
Media sequence=A4, A4, A4, A4, A4, A4
Exceeds the imaging area specified on pages=none
Copy counts=1
Finishing=bind
Layout sequence=one-sided, two-sided-head-to-head, two-sided-head-to-head, two-sided-head-to-head, two-sided-head-to-head, one-sided
Orientation sequence=portrait, portrait, portrait, portrait, portrait, portrait
Metadata: zip code=12345
Family 2—
Contains 60 instance documents
Page count=7
Media sequence=A4, A4, A4, A4, A4, A4, A4
Exceeds the imaging area specified on pages=none
Copy counts=1
Finishing=bind
Layout sequence=one-sided, one-sided, two-sided-head-to-head, two-sided-head-to-head, two-sided-head-to-head, two-sided-head-to-head, one-sided
Orientation sequence=landscape, portrait, portrait, portrait, portrait, portrait, portrait,
Metadata: zip code=55555
Family 3—
Contains 5 instance documents
Page count=6
Media sequence=A4, A4, A4, A4, A4, A4
Exceeds imageable area specified on pages=1, 3, 6
Copy counts=1
Finishing=bind
Layout sequence=one-sided, two-sided-head-to-toe, two-sided-head-to-toe, two-sided-head-to-toe, two-sided-head-to-toe, one-sided
Orientation sequence=portrait, portrait, portrait, portrait, portrait, portrait
Metadata: zip code=98765

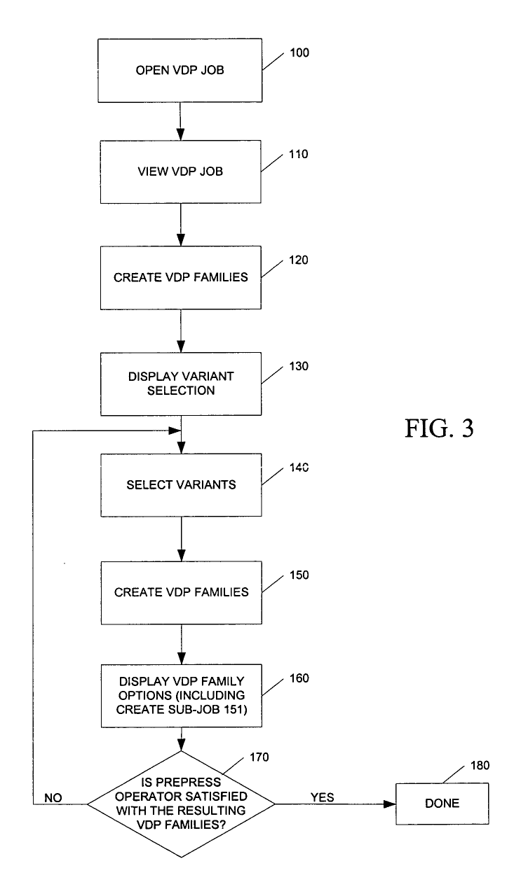

FIG. 3 is a flow diagram of the routine used by, the preferred embodiment of the present invention that is responsible for characterizing all of the instance documents and arranging them into groups called VDP Families. A VDP Family is a group of instance documents within a VDP job that contains equivalent values for the set of variants chosen by the prepress operator. It should be noted that an equivalent value as used within the context of the invention, is either a single value or a range of values, which each instance document within a VDP Family satisfies. From the list of VDP Families and their corresponding variants, the prepress operator should be able to clearly determine how to manufacture the entire VDP job. With the benefit of the PPML/VDX analysis to work from, the prepress operator may choose to manufacture each Family uniquely, or group any or all of the Families together to be manufactured the same.

Still referring to FIG. 3, Open VDP Job 100 is the entry point in the routine where the prepress operator opens the VDP prepress workflow component, which in the case of the present invention comprises opening a VDP job. View VDP Job 110 invokes the View VDP Job 23 capabilities previously discussed in conjunction with the description of FIG. 2, and allows the operator to view the composed form of the VDP job as it exists within the workflow application. An application menu pops up on GUI 6 and the prepress operator initiates the creation of VDP Families by selecting Create VDP Families 120 from the application menu. The selection of Create VDP Families 120 by the prepress operator results in the activation of Display Variant Selection 130. Display Variant Selection 130 is a display provided by the GUI 6 that presents a variety of variant parameters, that provides the prepress operator with a tool for the selection of variants by which instance documents will be sorted into VDP Families. Select Variants 140 is the process whereby the prepress operator selects variants from a combination of check boxes and text entry fields provided by Display Variant Selection 130. The variants chosen by the prepress operator will be used to create the VDP Families. Examples of variants are pages per instance document, number of copies required, media used, finishing requirement, pages that exceed the imaging area, page layout, page orientation, metadata, etc.

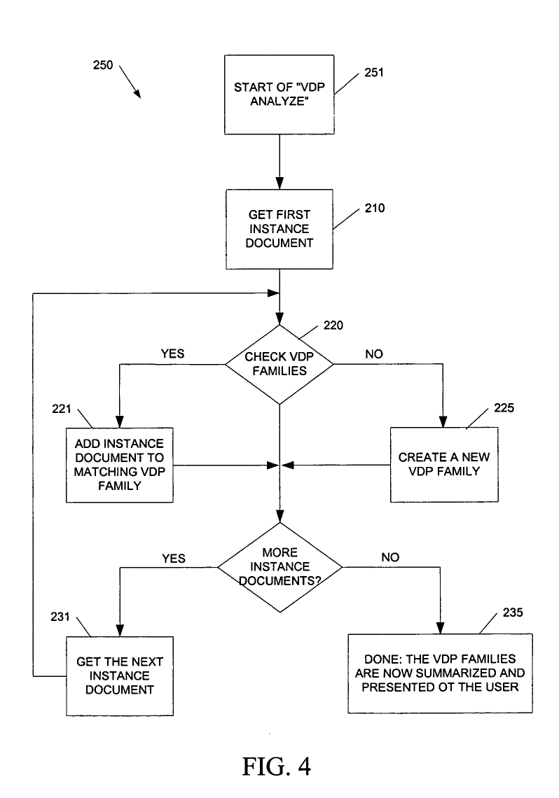

The prepress operator selects the variants that are to be employed, and the creation of VDP Families is initiated by VDP Analyze 250 as illustrated in FIG. 4. This is a more detailed flowchart for the Create VDP Families 150 to create the desired VDP Families. Returning to FIG. 3, once Create VDP Families 150 has run, Display VDP Family Options 160 presents the prepress operator with a list of VDP Families generated from the selected variants with the number of instance documents belonging to each family along with the variant's corresponding values. Satisfied with VDP Families 170 allows the prepress operator input to indicate if the resulting list of VDP Families is satisfactory or not. If the prepress operator is not satisfied, then the operator can indicate this dissatisfaction by inputting via the GUI 6 and operation is returned to Select Variants 140 where another list of parameters is selected. Once the prepress operator is satisfied with the list of VDP Families then an indication is made via the GUI 6 and the creation of VDP Families is Done 180. It should be noted that it is assumed that VDP Families are selected such that the overall VDP job is divided into groups of instance documents that can be manufactured alike providing for an overall improvement in the reliability and efficiency of fulfilling a VDP job.

Create Sub-Job 151 is an optional routine that is provided in Display VDP Family Options 160. Create Sub-Job 151 can be run by the operator after Create VDP Families 150. Create Sub-Job 151 is used when the operator believes that the VDP job is to large to be a single job, or for any reason that the operator desires to create jobs that are sub-sets of the VDP job. Create Sub-job 151 will be discussed in more detail below.

FIG. 4 is a flowchart that illustrates the VDP Analyze 250 routine used to perform the Analyze VDP Job 22 function that sorts instance documents to determine which VDP Family an instance document should be associated with. As previously stated, the VDP Families are created by a software component called Create VDP Families 150 that accepts a Variable Data Printing (VDP) job comprising many unique sub-documents (instance documents) and sorts them into groups of equivalent variants called VDP Families. VDP Analyze 250 begins once the VDP job enter prepress component 20 after the VDP job has been authored in the file format that is being employed. The preferred embodiment employs a PPML/VDX file format to author the VDP job. However, it will be understood by those skilled in the art that other file formats can also be used in place of a PPML/VDX file. Before the VDP Families routine illustrated in FIG. 4 can be run, the VDP job file (a VDX file in the preferred embodiment) is opened. The prepress operator then selects the desired variants and the sort routine is initiated via operator input to the GUI 6.

The VDP job description contained within the PPML/VDX file has numerous variants for the VDP job. The variants may include: page count; media types; number of copies; pages that exceed the imaging area; and finishing. The variants are specified by the prepress operator and result in groupings that can be used as parameters. A group of instance documents within a VDP job having equivalent variants can be sorted using variants as parameters to find the VDP Family. In an exemplary embodiment of the invention, a VDP Family will generally be determined by grouping on the order of about 5 parameters, however, the number of parameters can vary and the actual number employed can be more or less than 5 parameters or even a single parameter is possible. The operator selects the list of parameters used to sort instance documents into a particular VDP Family by entering the desired variants via the GUI 6. It would also be possible to have predetermined VDP Families with a predetermined list of parameters that determine the characteristics of a VDP Family. An example of a predetermined VDP Family is a sort routine run with three variants as parameters that characterize the VDP Family, such as: the number of pages per document; the finishing request; and the media. The parameter selection, preferably, implies which variants the prepress operator deems as relevant in helping manufacture the print job. Preferably, each instance document is sorted into exactly one VDP Family per sort operation. If another sort operation is performed applying different variants, then a particular instance document will be associated with a different VDP Family in accordance with that sort operation. It should be understood that while associating each instance document with only a single Family is the preferred mode of practicing the invention, other groupings are also possible wherein an instance document is associated with multiple Families simultaneously, and these differing embodiments will be readily apparent to those skilled in the art.

The Start VDP Analyze 251 routine begins with a VDP job as defined by the PPML/VDX file and a list of variants supplied by the operator to use for creating VDP Families. Once the VDP Analyze 250 algorithm is entered, Get First Instance Document 210 begins with an empty set of VDP Families and retrieves the first instance document in the VDP job. This first instance document is then examined to determine if an existing VDP Family has a matching set of variants.

Check VDP Families 220 compares the variants selected by the prepress operator with the variants that are listed within PPML/VDX file for the first instance document to see if there is an existing VDP Family with parameters equivalent to those listed for the current instance document. The variants that the prepress operator can select include: page count; media types; number of copies; pages that exceed the imageable area; finishing; page layout; page orientation; metadata; and other possible variants. The list of possible variants is not a closed list and it is specifically envisioned by the present invention that other variants can be employed. Check VDP Families 220 verifies that the selected variants exist within this instance document and that there is a match for a VDP Family already created for this VDP job. If there are variants within the instance document that are not found within the group of parameters specified by the prepress operator, then the routine Create a New VDP Family 225 is run to generate a new member to the list which is a match for the present instance document. Create a new VDP Family 225 creates a new member of the VDP Family with parameter values equivalent to the current instance document and then adds the current instance document to the new VDP Family member. If the variants specified by the prepress operator are found within the instance document, the instance document is then associated with the VDP Family that matches by Add Instance Document into VDP Family 221 which will place the current instance document to the VDP Family that has equivalent parameter values for all of the variants that are selected by the user.

More Instances Documents 230 will look to the list of instance documents to determine if there are there any more instance documents in the VDP job. If there are more instance documents to be sorted by VDP Analyze 250, Get Next Instance Document 231 will get the next instance document, and return to Check VDP Families 220 to compare the variants that are listed within the PPML file for this next instance document to find a VDP Family that matches the variants listed. The previously discussed steps for Check VDP Families are then repeated. The list of instance documents will be sorted through until a false answer for More Instance Documents 230 results in a return to the calling VDP Family routine and the VDP Family Sort is completed.

Once the VDP Analyze 250 completes the VDP Families sort routine, Done 235 will provide summarized information relating to the VDP Families to the prepress operator that will allow the prepress operator to understand and manufacture the entire VDP job accurately and efficiently. The analysis results in sorting every instance document into a VDP Family and describing the characteristics of each VDP Family in order to allow the prepress operator to instruct the NexStation printer how to manufacture the job. The directions to the NexStation 4 describing how to print each VDP Family are contained in a data structure called a job ticket. The job ticket is preferably a Portable Job Ticket Format (PJTF), which is a standard file format that is created by the Adobe Job Ticket and widely supported throughout the industry. Many companies have developed their own proprietary job ticket programs. While the present embodiment employs PJTF, it is specifically envisioned that future embodiments will eventually migrate to another format known as Job Definition Format (JDF). After the result of the VDP Analysis is available and the VDP Families are identified, the prepress operator selects/creates a job ticket to print the job. The job ticket is written in a standard file format that is compatible with software on the NexStation 4. Therefore, the NexStation 4 comprehends the information in the job file, and: which media to use; how to impose sheets; identifying if each sheet is one-sided or two-sided, or the type of finish. Once a job ticket is created, it may be attached to the PPML file and submitted to the NexStation 4 for fulfillment. Given the results of the analysis, the prepress operator immediately knows exactly what each Family looks like, how many instance documents are in each VDP Family, and can therefore create a job ticket ideally suited for each VDP Family. The job ticket associated with each VDP Family then tells the NexStation 4 which media types to use for each sheet, how to apply imposition of pages onto sheets, how many copies, how to finish, etc.

The prepress component 20 provides an Acrobat standard user interface for launching the Analyze VDP Job 22 function on a PPML/VDX file. The Acrobat standard user interface supports the specification of virtually any combination of variants (including support for wildcards) that Analyze VDP Job 22 (FIG. 2) uses as criteria for creating VDP Families (i.e. a column of variants each with a corresponding checkbox). An example of a list of variants is page count, media types, copies, number of pages that exceed the imaging area, finishing and any variants explicitly specified through “PRIVATE_INFO” within the PPML/VDX file. Prepress component 20 allows for a valid hierarchy of PPML/VDX tags and attributes to be entered as a variant (such as differentiating Families by zip code in PRIVATE_INFO:
<PRIVATE_INFO><Zip-Code>12345</Zip-Code></PRIV-ATE_INFO>).

The results of the “Analyze VDP job 22” are displayed in a clearly formatted text box on the user interface; and for each Family, displays the number of instance documents it contains and the parameter values of each variant.

With reference again to FIG. 1A, the invention envisions using a field of data for variant selection. A field of data, as used herein, can refer to data that is placed into an instance document from the recipient database 16 during the process of authoring 10. Typically, field of data refers to information that is placed into an instance document to assist in the printing and finishing of the document that is defined by that instance document. A field of data can comprise metadata detailing personal information relative to the intended recipient of the document. Another type of field of data as envisioned by the invention are the results of rules placed within the instance document by authoring component 10. These rules are applied to the instance documents within authoring component 10 so that rules will form part of the PPML/VDX file for the instance document when it is transferred to prepress component 20. An example of a rule would to be to test the age of a person, typically the recipient of the finished document, and change either the order of producing the document or the content of the document in accordance with the result of the age test. Another rule could be performing a test based on income as shown in Table 1 and depending on the income levels, merge process 14 will add a different picture into the instance document. The income of the intended recipient could also be used as a field of data to arrange the finished product. Brochures for expensive cars that will be sent to recipients capable of purchasing them might very well use a heavier, or more expensive type of media than brochures for inexpensive cars that will be sent to recipients with less income. Yet another rule could be the area where the recipients reside such as Germany or the United States. If a recipient resides in the United States, then a piece of variable data might say “HELLO”, whereas, if the recipient resides in Germany, the same portion of the finished document should read “GUTEN TAG”. The field of data that is applied to the instance documents from the recipient database allows not only the altering of content in the process of authoring 10, but also the manner in which the final documents are arranged for production in the area of prepress 20.

The arrangement of printed documents can be based on numerous features enunciated which can be contained within a field of data. Metadata related to the final recipients of the documents is very useful for organizational purposes because it allows the production of documents in accordance with recipient parameters. Recipient metadata can include: zip code; gender; income; country; hobbies; name; age or business. Using recipient metadata to arrange the printer's production of documents is advantageous in terms of cost, organization, and efficiency of printer set up. Efficiency in arranging final products is achieved through knowledge of the types of media, size of media and eliminating much of the collating for the final printed documents. A tool is needed to extract a subset of instance documents from a VDP job, and create a VDP Family based on recipient metadata. The exemplary embodiment uses authoring component 10 to place metadata into the instance documents and prepress component 20 to create groupings in accordance with the metadata. It is the area of authoring 10, where form and content are created and placed into instance documents prior to being sent to prepress component 20. The operator of the prepress 20 selects the desired metadata parameters that will generate a sub-grouping of VDP Families that will be printed together.

With reference again to FIG. 3, the prepress operator will choose a field of data as variants within Select Variants 140. Preferably, Display Variant Selection 130 will provide various menus including menus for variants related to fields of data. Then within Select Variants 140, the prepress operator can choose the desired field of data, such as metadata or rules applied to instance documents with authoring component 10, simply by picking a selection from a menu. The VDP Analyze 250 routine is called by Create VDP Families 150 in a manner similar to that previously described for the creation of VDP Families.

After opening a PPML/VDX file and running Create VDP Families 150, the prepress operator has several selections to choose from that are presented by Display VDP Family Options 160. One of the presented options is Create Sub-Job 151. Tools for selecting a set of instance documents are presented by the prepress workflow software component. Upon completion of selecting the set of instance documents for the new job, the new job is saved as a complete PPML/VDX file.

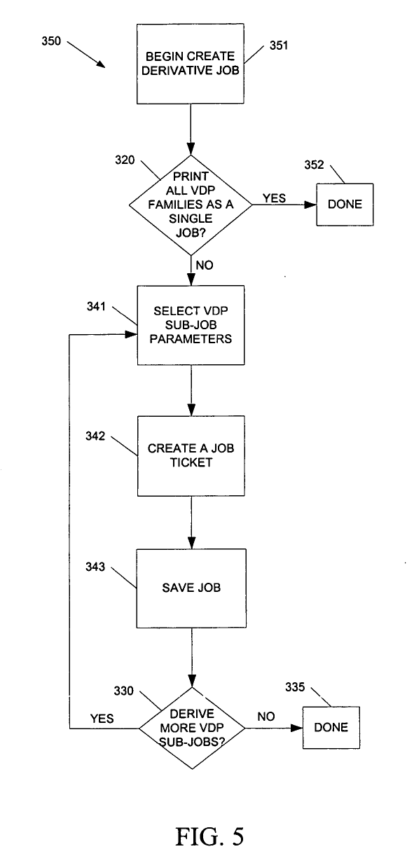

Referring to FIG. 5, Create a Derivative Job 350 is an optional routine that can be run after VDP Analyze 250 (FIG. 4), by selecting the Create Sub-Job 151 selections within Display VDP Family Options 160. Create Sub-Job 151 invokes the Create Derivative Job 350 which allows the operator to create multiple smaller print jobs from larger print jobs. The system software provides the capability of creating new VDP jobs as subsets of a larger VDP job in those instances where the operator finds it desirable for a print job to be produced as a group of separate, smaller VDP jobs. In order to create sub-jobs of a larger VDP job, a tool is needed to extract a subset of instance documents from a VDP job, and create a new VDP sub-job. Begin Create Derivative Job 351 is entered, upon operator selection of Create Sub-job 151 option from the Display VDP Family Options 160. In an exemplary embodiment, Begin Create Derivative Job 351 summarizes the VDP Families that were determined by VDP Analyze 250 and presents the VDP Families to the operator via the GUI 6. If the operator does not select Create Sub-Job 151 from the selections within Display VDP Family Options 160 the system immediately determines that Print All VDP Families as a Single Job 320 is answered in the affirmative which causes Create Derivative Job 350 to be Done 352. If the prepress operator selects Begin Create Derivative Job 351 within Display VDP Family Options 160, then Select VDP Sub-Job Parameters 341 will provide the operator with selections on the GUI 6 that include instance documents and VDP Families. The operator can select instance documents, or ranges of documents, from the parent VDP job as parameters for the derived VDP sub-job. The operator can also select entire VDP Families to use as parameters for the derived VDP sub-job. Upon selection of the parameters used for creating the derived VDP sub-job, Create a Job Ticket 342 will form a manufacturing specification for the derived VDP job. Save Job 343 stores the derived VDP sub-job. The operator is then presented with a determination in Derive More VDP Sub-Jobs 330, which if responded to affirmatively by the operator returns operation to Select VDP Sub-Job Parameters 341. If the operator response to Derive More VDP Sub-Jobs 330 is negative, then Done 335 returns operation to the main VDP Families routine.

In summary, the following flow of events creates new sub-jobs from the original PPML/VDX jobs: (1) the prepress operator selects “VDP Analyze;” (2) the prepress operator selects “Create Derivative Job;” (3) the prepress workflow software component provides an user interface to systematically select a set of instance documents to include in the new job; (4) the prepress operator selects “Save New Job” to the file system.

Requirements

To run the routine “Create Derivative Job” 350 selection as provided by the GUI 6, the system shall have the “Save New Job” function gather all selected instance documents from a list into a new PPML/VDX file, along with all referenced PDF contents. The software shall run as an Acrobat plug-in and support all typical Acrobat file operations (open, close, save, save as) on *.vdx files. The exemplary embodiment envisions recognition of all VDX semantics within a *.vdx file.

The system software envisions the capability to associate a Document Type Definition (DTD). A DTD is a file that verifies that an XML (PPML) file is formatted legally and in compliance with an intent. The intent here is that the file is a PPML/VDX file. An alternative to a DTD is called a schema. Either of these two methods can be utilized for validating the structure of a PPML/VDX file. The system software also provides the option to test the XML portion of the PPML/VDX file for being “valid” or “well-formed”. In the exemplary embodiment, the system software disallows editing a PPML/VDX file from within the Acrobat environment, however, it should be understood that those skilled in the art will foresee the capability for editing within an Acrobat environment and these variations are specifically envisioned by the present invention.

Referring again to FIG. 2, Define Manufacturing Intent 25 is a function that is performed by the prepress component 20 in order to define the production parameters that are responsible for manufacturing the job as intended. Define Manufacturing Intent 25 is a function that sets the production parameters accurately and efficiently, to print and finish the print job as specified in a PPML/VDX file. The prepress operator should be aware of the capabilities of the device in order to determine the optimal way to print and finish a PPML/VDX job. Therefore, one of the functions of Define Manufacturing Intent 25 is to query the printing device (e.g., NexStation 4) for its “Manufacturing Capabilities”. Included in “Manufacturing Capabilities” for the device are the “Media Catalog” 39, the “Static Imposition Template Catalog” 38, and the “Finishing Capabilities”. Communication between the prepress component 20 and the PPML/VDX job production component 30 provides a list of the available media types obtained from the Media Catalog 39. The prepress operator maps each logically specified media in the VDP Family to a physical media type supported in the Media Catalog 39 of the device's Manufacturing Capabilities. An imposition scheme is selected that will accurately and efficiently print each instance document of the VDP Family. An imposition scheme for a VDP Family can be specified in several different ways:
1. selecting an imposition template from the printing device's (e.g., NexStation 4) “Static Imposition Template Catalog” 38;
2. not specifying any imposition scheme and thus allowing the device to perform imposition using it's default imposition scheme;
3. associating a job ticket from the file system which contains “Static Imposition Template”; and
4. selecting parameters for specifying a simple (typically 1-up) “Static Imposition Template.”

The selection of a static imposition template for a VDP Family involves consideration of the mapping of the logically specified media and finishing specifications in the PPML/VDX to the physical capabilities of the device. PPML/VDX pages may have a logical media name (such as “Heavy Letter”, “Insert1”, or “Dave's Favorite Paper Type”) which the prepress operator assigns to a specific paper defined in the device's Media Catalog (such as “Hammermill #06200-8”) based on communication between the prepress operator and the PPML/VDX job producer. Additionally, the prepress operator determines what page layout will yield the best results. The VDP Family may have a logically specified finishing requirement (such as “saddle-stitch” or “bind”) which needs to be mapped to a physical finishing capability of the device and defined in an Adobe job ticket. Finally, the number of copies to be produced of each instance document in the VDP Family needs to be considered. There are some cases (e.g., business cards, postcards) in which multiple copies of the same instance document should be imposed in a particular orientation. The assigning of a static imposition template and job ticket will direct the device to accurately and efficiently produce the VDP Family.

The system software of the present invention is able to define the production parameters of a PPML/VDX job by treating the entire file as a single Family. This intermediate level of functionality is viewed in conjunction with the capability of having the ability to split a multiple VDP Family job into single VDP Family sub-jobs. The functionality of treating the PPML/VDX job as a single file allows for a single file production of a PPML/VDX job with multiple VDP Families.

Once the PPML/VDX file has been opened by the prepress component 20, the prepress operator will obtain the results of Analyze VDP job 22. In order to define production parameters, the prepress operator selects a device (e.g., NexStation 4) and queries the device for its manufacturing capabilities. Once the manufacturing capabilities are received, the prepress operator selects a VDP Family from the list created by Analyze VDP Job 22 to define the production parameters needed for manufacturing that subset of the PPML/VDX job.

A communications interface between the prepress component 20 and production component 30 areas allows the prepress operator to map the logically specified media and finishing contained within the VDP Family to a physical media and finishing option supported in the device's manufacturing capabilities.

After reviewing all production parameter selections, the prepress operator may accept the selections for that VDP Family. The result of the production parameter selections is then put into a job ticket which will describe the manufacturing intent of the production parameters, and reference which instance documents within the PPML/VDX job that this set of productions parameters are to be applied. Note that within the exemplary embodiment, the job ticket format will be PJTF or JDF, however, is should be understood that other formats can be employed as will be readily apparent to those skilled in the art.

The foregoing steps are then repeated for each VDP Family from the Analyze VDP 250 function. The prepress operator then confirms that all VDP Families are properly specified for production. Any final job ticket processing is completed. The PPML/VDX job is then ready for submission.

The Define Manufacturing Intent 25 uses system software to present results of Analyze VDP Job 22 on the GUI 6 which then allows the prepress operator to specify all required production parameters for each VDP Family. The list of required parameters to be specified for each VDP Family from the manufacturing capabilities provided by the selected NexStation 4 are as follows: the number of copies of each instance document in the VDP Family to be produced; a default physical media type for all PPML/VDX pages not explicitly specified with a logical media type; a physical media type for each logical media type specified; a static imposition template; and finishing capability.

The system software requests the prepress operator to confirm when finished making production selections on any or all VDP Families. It is, therefore, not required that all VDP Families be selected for production. The system software adds the confirmed production selections for all VDP Families into Adobe job ticket(s), which in the exemplary embodiment is based on PJTF. However, it will be readily apparent to those skilled in the art that other data structures can also be employed, such as JDF for example. The system software supports rule-based job ticket merging after a Job Ticket has already been embedded into a PPML/VDX job by a prior process. The system software embeds the associated Adobe job ticket(s) into the PPML/VDX file as specified by Adobe for PDF files.

Job Submissions 27 is a function that provides the operator of the prepress component 20 with the capability to open the PPML/VDX file and perform desired actions prior to submitting the PPML/VDX file to production component 30. Job Submissions function 27 submits a job in a PPML/VDX format to a printing device for fulfillment after all operations on the VDP job are completed by the prepress 20 operator. In the exemplary embodiment, Job Submissions 27 is done as a single file exchange. The exemplary embodiment implements a single file which contains all of the PPML, referenced PDF objects and any associated job ticket. However, it is specifically envisioned that in other implementations that allow for a multi-file submission, the PPML may refer to PDF objects in an external file.

Job Submissions 27 begins with the operator for prepress component 20 selecting the device for printing, which in the preferred embodiment is the NexStation 4, however other devices also are envisioned as being supported. For example, if all pages in a job are to be printed in black and white, then a black and white printer would be the preferred device. In the prepress 20 area, the prepress operator logs onto the device, depending upon the configuration of the device, and selects “Print Properties” to access device dependent capabilities. The desired print parameters that the device presents to the client are selected and confirmed (like a PPD). These selected parameters are then added to the Adobe job ticket that is embedded into the PPML/VDX file. If the PPML/VDX file already had a job ticket, then the new parameters are merged into the existing data structure. If there was no job ticket previously, then one is created and added. The prepress operator selects “Print” and the selected device receives the PPML/VDX file, performs job ticket merging, proceeds to RIP 32 and processes the job. Alternatively, the file can be exchanged for printing at a later time by selecting the device for printing. Having the knowledge and experience of the job and the print device, the operator simply moves the PPML/VDX file into a pre-defined and debugged Virtual Printer that has been created on the device (e.g., NexStation 4). The PPML/VDX file may or may not have an embedded job ticket at the time of transfer to NexStation 4.

Within the preferred embodiment, the system supports and integrates a NexStation 4 print driver as well as a GUI 6 to launch and support a NexStation 4 print driver. The GUI 6 allows selection and submission by submitting the PPML/VDX job to the selected device (NexStation 4 or other printing device). It is envisioned by the invention to employ network browsing, provided by the system, to locate existing virtual printers or other printing devices for the NexStation 4. The invention also envisions future re-printing provided by having the printing device selected by the job ticket so that the job can be identically reproduced. Upon selection of a “Print” command, the system software moves the selected PPML/VDX file to the input queue of the selected NexStation 4 or other printing device.

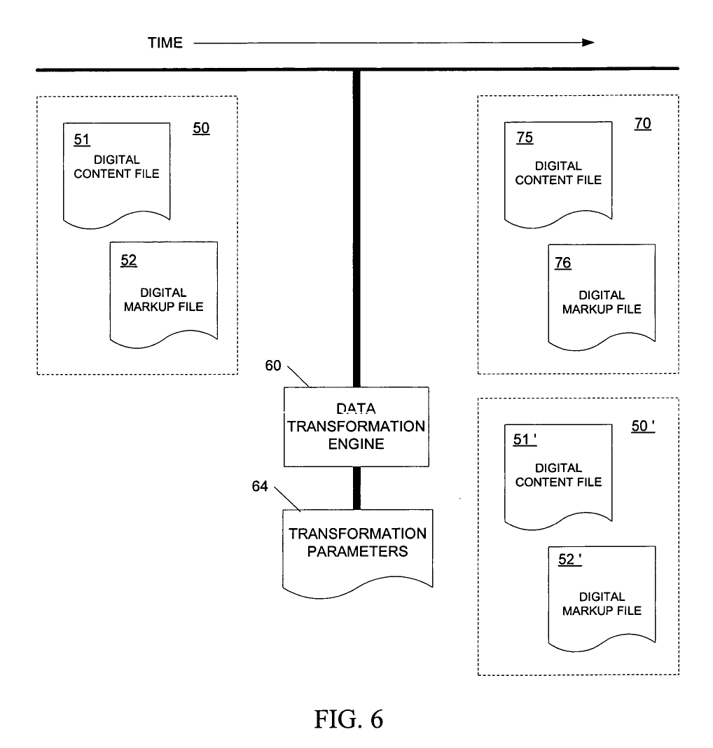

FIG. 6 provides a summary of the flow of information in order to select certain records from a list of existing digital content files. The Digital Document 50 file or files encode the content and their respective layout into digital form. A Digital Content file 51 contains page independent text, graphics and vector-data. These pages are referenced by the Digital Markup file 52. The Digital Markup file 52 is specified in text format and provides the semantic and syntactic mechanism for definition, positioning, meta-information, and structuring of the data referenced in the Digital Content file 51.

The Digital Content file 51 is described and encoded in the Portable Document Format (PDF) language, a language that provides for page independence of graphics (image and vector) and textual data. The Digital Markup file 52 is described in the Extensible Markup Language (XML).

The present invention includes a Data Transformation Engine 60 and input Transformation Parameters 64 to control the formulation of an updated Digital Content file 51′ or a new Digital Content file 75 from a previously existing (i.e., original) Digital Content file 51. The creation of a revised Digital Content file 51′ or new Digital Content file 75 is the result of applying Transformation Parameters 64 to the Digital Markup file 52, using the Data Transformation Engine 60. The Data Transformation Engine 60 uses Extensible Stylesheet Language for Transformations (XSLT) to apply transformation parameters to the Digital Markup file 52.

XSLT is a standard way to describe how to transform (i.e., change) the structure of an XML document into an XML document with a different structure. XSLT is a language that can transform XML documents into any text-based format. XSLT is used to describe how to transform the source tree or data structure of an XML document into the result tree for a new XML document, which can be completely different in structure. XSLT relies on finding parts of an XML document that matches a series of predefined templates and then applies transformation and formatting rules to each matched part.

Multiple criteria can be developed to define the Transformation Parameters 64 to be applied to specific records based on known selection criteria. Some example selection criteria include selection of documents and/or pages that need to be reprinted for a digital print production system. A person or computer system can generate reprint data Transformation Parameters 64 required with respect to the original Digital Content file 51. Using the input parameters provided, the Transformation Parameters 64 are created by a user or computer system and passed to the Transformation Engine 60 where they are then applied to the Digital Content file 51 to produce a new Digital Content file 75 or a revised Digital content file 51′.

The Transformation Parameters 64 provides a discrete selection criteria for the Transformation Engine 60. The selection criteria could be related to the Digital Content file 51, Digital Markup file 52, data stored within the Digital Content file 51, data stored within the Digital Markup file 52, geographic data stored within the Digital Content file 51 or Digital Markup file 52, data stored within a customer database, an external program generating parameters, or other additional means for a user to specify parameters for the creation of a new Digital Content file 75 or revised Digital Content file 51′.

The Data Transformation Engine 60 is a software service or component that can be located either in the NexStation front end 4 or into an external software application. The Data Transformation Engine 60 takes the Digital Markup file 52 stored within the initial Digital Document 50 and applies a data transform to that file. The data transform is controlled and manipulated by the input Transformation Parameters 64. Using these parameters, the Data Transformation Engine 60 alters the Digital Markup file 52 to create a revised instance of the Digital Markup file 76 (for new Digital Content file 75) or 52′ (for revised Digital Content file 51′). The results of this transformation changes the assembled view of the Digital Document 70 or 50′, respectively.

As an example of a scenario in which the need for the present invention can arise, consider the situation of a large financial company that has created a 401K application in a design and authoring software application (e.g., authoring process 10 in FIG. 1). The 401K application is a single Digital Document 50 for the 1000 customers who recently purchased units in an equity mutual fund covered by the 401K plan. Consider further that this statement and summary reports need to be sent to the 1000 customers within one week. The software application created in the authoring process 10 represents the file in a PDF format (i.e., Digital Document 50). The financial company needs to create a printed document for their customers, so it sends the PDF file to a print service provider having a printer such as the NexPress 2100. The print service provider takes the PDF input file and submits the variable data print job to the NexStation front end 4. The NexStation front end 4 processes the PDF file and creates printed sheets using the NexPress 2100. Once the print job is completed, the printed material is sent to finishing, fulfillment and distribution facilities where the 401K statements are scored, folded, placed in an envelope and postmarked by the facilities. The customer then receives the 401K statement through the postal service. However, in the finishing process, printed documents are frequently damaged in the handling and preparation for final assembly. During this handling, several to numerous printed sheets are damaged and require reprinting. In a worst case scenario, the entire 401K application job would be reprinted. Reprinting the entire job is both too time-consuming and too costly. The present invention solves this type of problem as described in the following paragraphs for this example scenario.

A post-press worker within the print service provider's facilities examines the printed sheets for a means to identify uniquely each document requiring reprinting. The post-press worker tries to locate any of the following identifiers on the damaged document: a barcode, a customer identification code, a customer name, a job or sheet name, and/or a tracking code. Once any of these (or, more generally, other identifiers) are located, the post-press worker records the unique codes from each damaged sheet.

Assume that the post-press worker has found 10 damaged sheets and a unique code on each sheet. The post-press operator provides this information along with the PDF job filename to the press operator. The press operator locates the PDF file that has been processed previously by the NexStation front end 4. Using the GUI 6, the press operator selects the correct PDF file and inputs the 10 unique identifying codes into the NexStation front end 4. These unique codes are stored in the NexStation front end 4 and represent the inputs into the Data Transformation Engine 60. NexStation front end 4 takes the codes provided and translates them into the appropriate Transformation Parameters 64. The Data Transformation Engine 60 located in NexStation front end 4 then applies the Transformation Parameters 64, creates a new Digital Content file 70 or revised Digital Content file 51′ and notifies the press operator that the 10 sheets from the previous job need to be reprinted. The press operator acknowledges the reprint needs, submits the job, and prints the 10 sheets. The press operator then provides the 10 reprinted sheets to the post-press worker.

In an automatic mode of operation, instead of the post-press operator and the press operator exchanging the data needed for selective reprint of 401K records, a software and/or hardware component can communicate the Digital Content file or files 51 that need to be reprinted. The software identifies and communicates which sheets were damaged to the digital printing device using the unique identification code on the printed material. These codes are stored in the NexStation front end 4 and represent the input into the Data Transformation Engine 60. The NexStation front end 4 takes the codes provided and translates them into the appropriate Transformation Parameters 64. The Data Transformation Engine 60 located in the NexStation front end 4 then applies these parameters, creates a new Digital Content file 75 or revised Digital Content file 51′, and automatically reprints the 10 sheets required. The press operator then gives the post-press worker the 10 sheets requested.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the foregoing description of the exemplary embodiments of the present invention are possible without departing from the spirit and scope of the present invention.

What is claimed is:

1. A method for selective reprint of individual records in a variable data printing operation, comprising the steps of:
providing a variable data print job defined by a first digital document including a plurality of records to a printing device;
examining a plurality of printed documents to determine which records to reprint;
determining a parameter to identify the records to reprint;
applying the identifying parameter to the first digital document;
transforming the first digital document into a second digital document including the records to reprint; and
providing a print job defined by the second digital document to the printing device.

2. The method for selective reprint of individual records of claim 1, wherein each digital document is an electronic file comprising a digital content file and a digital markup file.

3. The method for selective reprint of individual records of claim 1, wherein each digital document encodes a digital content and a layout of content in the digital document.

4. The method for selective reprint of individual records of claim 2, wherein the digital content file includes at least one of page independent text, graphics and vector-data.

5. The method for selective reprint of individual records of claim 2, wherein the digital content file is described and encoded in a Portable Document Format (PDF) language.

6. The method for selective reprint of individual records of claim 2, wherein the digital markup file is specified in text format and provides a mechanism for at least one of definition, positioning of meta information and structuring of the digital content file.

7. The method for selective reprint of individual records of claim 1, wherein the step of applying the identifying parameter to the first digital document comprises inputting the identifying parameter to a data transformation engine.

8. The method for selective reprint of individual records of claim 2, wherein the digital markup file is specified using Extensible Markup Language (XML).

9. The method for selective reprint of individual records of claim 7, wherein the data transformation engine is based on Extensible Stylesheet Language for Transformations (XSLT).

10. The method for selective reprint of individual records of claim 2, wherein the step of transforming the first digital document comprises the steps of applying a data transform to the digital markup file and controlling the data transform using the applied identifying parameter.

11. The method for selective reprint of individual records of claim 2, further comprising the step of creating a revised instance of the digital markup file as a result of the transforming step.

12. The method for selective reprint of individual records of claim 2, wherein the step of determining a parameter to identify the records to reprint comprises selecting the parameter based on criteria related to at least one of data stored within the first digital content file, data stored within the digital markup file, data stored within a customer database, and an external software program that generates parameters.

13. The method for selective reprint of individual records of claim 1, wherein the step of determining a parameter to identify the records to reprint comprises the step of recording a unique code corresponding to each record to reprint.

14. The method for selective reprint of individual records of claim 13, wherein the unique code comprises at least one of a record barcode, a customer identification number, a customer name, a job name, a sheet name, and a tracking code.

15. The method for selective reprint of individual records of claim 1, further comprising the step of printing the identified records as provided by the second digital document.

16. A system for selective reprint of individual records in a variable data printing operation, comprising:
a printing device for rendering a first digital document as defined by a variable data print job, wherein the first digital document includes a plurality of records provided to the printing device; and
a data transformation engine, cooperative with the printing device, for transforming the first digital document into a second digital document that includes the records identified for selective reprint by the printing device.

17. The system for selective reprint of individual records of claim 16, wherein the data transformation engine is a software component resident on the printing device.

18. The system for selective reprint of individual records of claim 16, wherein the data transformation engine is a software application external to the printing device.

19. The system for selective reprint of individual records of claim 16, wherein each digital document is an electronic file comprising a digital content file and a digital markup file.

20. The system for selective reprint of individual records of claim 16, wherein each digital document encodes a digital content and a layout of content in the digital document.

21. The system for selective reprint of individual records of claim 19, wherein the digital content file includes at least one of page independent text, graphics and vector data.

22. The system for selective reprint of individual records of claim 19, wherein the digital content file is described and encoded in a Portable Document Format (PDF) language.

23. The system for selective reprint of individual records of claim 19, wherein the digital markup file is specified in text format and provides a mechanism for at least one of definition, positioning of meta information and structuring of the digital content file.

24. The system for selective reprint of individual records of claim 19, wherein the data transformation engine transforms the first digital document into a second digital document by applying a data transform to the digital markup file and controlling the data transform using an identifying parameter.

25. The system for selective reprint of individual records of claim 16, wherein the data transformation engine is based on Extensible Stylesheet Language for Transformations (XSLT).

26. The system for selective reprint of individual records of claim 19, wherein the digital markup file is specified using Extensible Markup Language (XML).

27. The system for selective reprint of individual records of claim 24, wherein the identifying parameter identifies the records to reprint and is selected based on criteria related to at least one of data stored within the digital content file, data stored within the digital markup file, data stored within a customer database, and an external software program that generates parameters.

28. The system for selective reprint of individual records of claim 24, wherein the identifying parameter identifies the records to reprint based on a unique code corresponding to each record to reprint.

29. The system for selective reprint of individual records of claim 28, wherein the unique code comprises at least one of a record barcode, a customer identification number, a customer name, a job name, a sheet name, and a tracking code.

30. The system for selective reprint of individual records of claim 19, wherein the data transformation engine creates a new instance of the digital markup file as a result of transforming the digital document.
